(19) United States
(12) Patent Application Publication
(10) Pub. No.: US 2025/0271098 A1
(43) Pub. Date: Aug. 28, 2025

(54) GRAB BAR ASSEMBLY

(71) Applicant: Kohler Co., Kohler, WI (US)

(72) Inventors: Andrew Rieth, Howards Grove, WI (US); Yutong Wu, Oak Creek, WI (US)

(73) Assignee: Kohler Co., Kohler, WI (US)

(21) Appl. No.: 19/060,302

(22) Filed: Feb. 21, 2025

Related U.S. Application Data
(60) Provisional application No. 63/557,063, filed on Feb. 23, 2024.

(51) Int. Cl. F16M 13/02; A47K 17/02

(52) U.S. Cl. CPC F16M 13/02; A47K 17/022; F16M 2200/024

(57) ABSTRACT

The present disclosure is generally directed towards an accessory mounting assembly for mounting an accessory on a grab bar. The accessory mounting assembly includes an accessory mount and a mounting bracket. The accessory mount is configured to releasably couple to the accessory. The mounting bracket assembly includes a first mounting portion and a second mounting portion. The first mounting portion is coupled to the accessory mount. The second mounting portion is releasably coupled to the first mounting portion. When the second mounting portion is coupled to the first mounting portion, the first mounting portion and the second mounting portion collectively define a bar opening configured to receive a portion of the grab bar to couple the accessory mounting assembly to the grab bar.

### CROSS-REFERENCE TO RELATED PATENT APPLICATIONS

This application claims the benefit of and priority to U.S. Provisional Patent Application No. 63/557,063, filed Feb. 23, 2024, which is incorporated herein by reference in its entirety.

### SUMMARY

One embodiment of the present disclosure relates to an accessory mounting assembly for mounting an accessory on a grab bar. The accessory mounting assembly includes an accessory mount and a mounting bracket. The accessory mount is configured to releasably couple to the accessory. The mounting bracket assembly includes a first mounting portion and a second mounting portion. The first mounting portion is coupled to the accessory mount. The second mounting portion is releasably coupled to the first mounting portion. When the second mounting portion is coupled to the first mounting portion, the first mounting portion and the second mounting portion collectively define a bar opening configured to receive a portion of the grab bar to couple the accessory mounting assembly to the grab bar.

Another embodiment of the present disclosure relates to a grab bar assembly. The grab bar assembly includes a grab bar configured to be coupled to a surface and an accessory mounting assembly configured to mount an accessory on the grab bar. The accessory mounting assembly includes an accessory mount, a mounting bracket assembly, and a lock assembly. The accessory mount is configured to releasably couple to the accessory. The mounting bracket assembly includes a first mounting portion coupled to the accessory mount and a second mounting portion. The first mounting portion defines a first aperture. The second mounting portion defines a second aperture. The lock assembly is configured to selectively align with and extend through the first aperture and the second aperture to selectively couple the second mounting portion to the first mounting portion. The lock assembly adjustable between a first configuration that couples the second mounting portion to the first mounting portion and a second configuration that releases the second mounting portion from the first mounting portion. The first mounting portion and the second mounting portion releasably couple the accessory mounting assembly to a portion of the grab bar when the grab bar is positioned between the first mounting portion and the second mounting portion and the lock assembly is in the first configuration.

Yet another embodiment of the present disclosure relates to an accessory mounting assembly for mounting an accessory on a grab bar. The accessory mounting assembly includes an accessory mount, a mounting bracket assembly, and an engagement assembly. The accessory mount is configured to releasably couple to the accessory. The mounting bracket assembly includes a first mounting portion and a second mounting portion. The first mounting portion is coupled to the accessory mount. The first mounting portion defines a first aperture, The second mounting portion defines a second aperture configured to selectively align with the first aperture to receive a fastener to releasably couple the second mounting portion to the first mounting portion. The first mounting portion and the second mounting portion releasably couple the accessory mounting assembly to the grab bar when a portion of the grab bar is positioned between the first mounting portion and the second mounting portion and the fastener couples the second mounting portion to the first mounting portion. The engagement assembly is adjustable between a first configuration where the engagement assembly engages the portion of the grab bar to inhibit movement of the accessory mounting assembly relative to the grab bar and a second configuration where the engagement assembly releases the portion of the grab bar.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a front view of several example grab bar assemblies;

FIG. 2 is a front view of several example grab bar assemblies;

FIG. 3 is a cross section view of a grab bar of one of the grab bar assemblies of FIG. 1, taken along plane A-A;

FIG. 4 is a perspective side view of an example accessory mounting assembly of one of the grab bar assemblies of FIG. 1 or 2 in a perpendicular orientation;

FIG. 5 is a perspective side view of the accessory mounting assembly of FIG. 4 in a parallel orientation;

FIG. 6 is a perspective side view of the accessory mounting assembly of FIG. 4 with a release handle of the accessory mounting assembly in a first position;

FIG. 7 is a perspective side view of the accessory mounting assembly of FIG. 4 with a release handle of the accessory mounting assembly in a second position;

FIG. 8 is an exploded view of the accessory mounting assembly of FIGS. 4-7;

FIG. 9 is a perspective side view of another example accessory mounting assembly of one of the grab bar assemblies of FIG. 1 or 2 in a parallel orientation;

FIG. 10 is an exploded view of the accessory mounting assembly of FIG. 9; and

FIG. 11 is an exploded view of the accessory mounting assembly of FIG. 9.

It will be recognized that some or all of the Figures are schematic representations for purposes of illustration. The Figures are provided for the purpose of illustrating one or more implementations with the explicit understanding that they will not be used to limit the scope or the meaning of the claims.

### BACKGROUND

The present disclosure relates generally to a grab bar assembly with an accessory holder assembly.

Grab bar assemblies are commonly used in home bathroom configurations. Grab bar assemblies are desirable because they allow for a person utilizing the home bathroom configurations to support themselves while using the home bathroom configurations. For example, a person may utilize a grab bar of a grab bar assembly while entering or exiting a shower area, entering or exiting a bathtub area, or sitting on or standing up from a toilet. Additionally, the grab bars may be utilized for additional applications such as hanging towels for drying. However, conventional grab bar assemblies may not be configured to support slidable accessories that the person utilizing the home bathroom configurations may find helpful. Additionally, even if conventional grab bar assemblies are configured to support slidable accessories, the grab bars supporting the slidable accessories are circular, which may be difficult for a person to grip.

It would be advantageous to provide a grab bar assembly that is configured to support slidable accessories that address one or more of the aforementioned issues.

### DETAILED DESCRIPTION

Following below are more detailed descriptions of various concepts related to grab bar assemblies that include accessory holder assemblies. The various concepts introduced above and discussed in greater detail below may be implemented in any of a number of ways, as the described concepts are not limited to any particular manner of implementation. Examples of specific implementation and applications are provided primarily for illustrative purposes.

### I. Overview

Grab bar assemblies (e.g., handrails, bath rails, safety bars, etc.) may be installed in bathroom configurations (e.g., bathrooms, rest rooms, etc.) to provide an object for a user to hold, for example while utilizing in a home bathroom configuration. In some applications, the grab bar assemblies may be installed proximate (e.g., next to, nearby, etc.) elements of the bathroom configurations such as showers, toilets, or bathtubs such that a user utilizing the element may hold the grab bar assembly. In some applications, the grab bar assemblies may be coupled to walls of the bathroom configurations. In other applications, the grab bar assemblies may be coupled to the elements of the bathroom configurations (e.g., to a toilet, to a shower, to a bathtub, etc.). When the user holds the grab bar assembly, for example, the user may use the grab bar assembly for stability or support.

While using the elements of the bathroom configurations, particularly non-commercial configurations such as for a home, hotel, resort, or the like, the user may desire to use accessories related to the elements. For example, while a user is using a shower, the user may desire to use a showerhead (e.g., to wash a body of the user, etc.). An accessory holder of the grab bar assemblies may be configured to support the accessories on the grab bar assemblies. Typical accessory holders may be secured to a position along a grab bar of the grab bar assemblies or may slide along the grab bar to a number of positions along the grab bar. For example, some accessory holders may be configured to slide along a shower grab bar to position a showerhead accessory along the shower grab bar. However, these accessory holders may not be removable from the grab bar. As a result, such accessory holders are limited to a single grab bar and cannot be transferred between grab bars of the grab bar assembly.

The grab bar assemblies may be positioned near the elements of the home bathroom configurations that produce liquid (e.g., a shower, a bathtub, etc.). As a result, the grab bar assemblies may become wet during operation of the elements of the home bathroom configurations. The liquid may cause the grab bar assemblies to become slick, which may make it difficult for a user to grasp the grab bar of the grab bar assemblies for support.

Implementations described herein are related to an accessory holder of a grab bar assembly that is fully removeable from grab bars of the grab bar assembly. As a result, the accessory holder described herein may be transferred between the gab bars of the grab bar assembly such that the accessory holder may hold an accessory in multiple positions on each of the grab bars.

Furthermore, the grab bars of the grab bar assembly may have a rectangular profile that is easier for a user to grab than a typical grab bar with a circular profile. As a result, the grab bars of the grab bar assembly may be easier for a user to grasp than a typical grab bar with a circular profile, especially when the grab bars are slick with liquid.

### II. Example Grab Bar Assembly

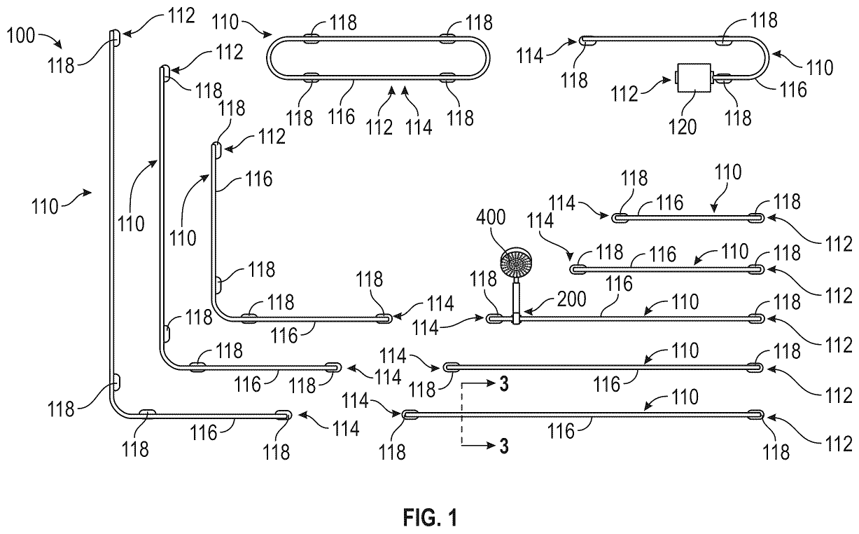

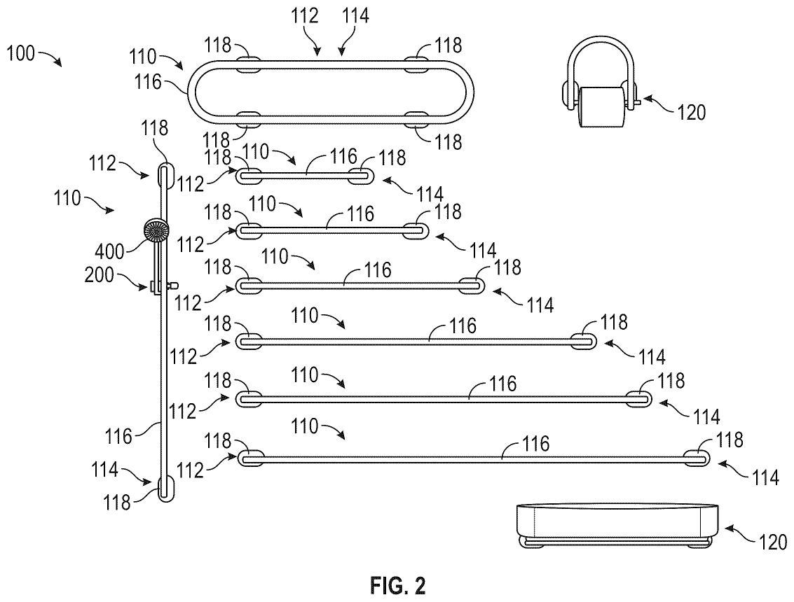

FIGS. 1 and 2 depicts a grab bar assembly 100 (e.g., a safety rail assembly, a grab bar kit, etc.) configured to be grabbed (e.g., grasped, held, etc.) by a user (e.g., a person, a bather, etc.) to stabilize the user. The grab bar assembly 100 includes a grab bar 110 and an accessory mounting assembly 200 (e.g., an accessory holder assembly, etc.). In various embodiments, the grab bar assembly 100 includes a plurality of the grab bars 110 and/or a plurality of the accessory mounting assemblies 200. For example, the grab bar assembly 100 may be configured as a grab bar kit that includes multiple of the grab bars 110 and multiple of the accessory mounting assembly 200. In other embodiments, the grab bar assembly 100 includes a single of the grab bars 110 and multiple of the accessory mounting assembly 200 or multiple of the grab bars 110 and a single of the grab bars 110.

The grab bar 110 is configured to be grabbed by the user to stabilize the user. In some embodiments, the grab bar 110 is configured to be installed on walls of a home bathroom configuration (e.g., walls of a bathroom, etc.) near elements (e.g., a toilet, a shower, a bathtub, etc.) of the home bathroom configuration. For example, a first of the grab bars 110 may be installed inside of a shower and a second of the grab bars 110 may be installed near a toilet. The first of the grab bars 110 may be grasped by the user to stabilize the user while the user is showering and the second of the grab bars may be grasped by the user to stabilize the user while the user is using the toilet. The grab bar 110 includes a first end 112. The grab bar 110 includes a second end 114 opposite the first end 112.

The grab bar 110 includes a bar 116 (e.g., tube, pipe, etc.) extending along a length of the grab bar 110 from the first end 112 to the second end. The bar 116 is configured to be grabbed by the user. In some embodiments, the bar 116 is formed of a hollow tube. In some embodiments, the bar 116 is covered, such as partially, by a slip resistant material (e.g., a rubber, a tacky material, etc.). For example, the bar 116 may be coated with a tacky film to increase a surface friction of the bar 116.

In some embodiments, the bar 116 extends substantially straight from the first end 112 of the grab bar 110 to the second end 114 of the grab bar 110. For example, the bar 116 may have a length of 12 inches, 18 inches, 24 inches, 36 inches, 42 inches, or 48 inches and may extend in a substantially straight line from the first end 112 of the grab bar 110 to the second end 114 of the grab bar 110. In other embodiments, the bar 116 includes a first portion and a second portion and the second portion may extend substantially perpendicularly (e.g., at a 90 degree angle, etc.) from the first portion. For example, the first portion of the bar 116 may extend from the first end of the grab bar 110. The second portion of the bar 116 may extend perpendicularly from the first portion of the bar 116 to the second end of the grab bar 110. The first portion of the bar 116 may have a first length of 18 inches, 36 inches, or 48 inches and the second portion of the bar 116 may have a second length of 18 inches, 36 inches, or 48 inches.

In still other embodiments, the bar 116 extends in a continuous loop from the first end 112 of the grab bar 110 to the second end 114 of the grab bar 110 such that the first end 112 intersects with the second end 114 to form a loop (e.g., an oval, a circle, a closed shape, etc.). In other embodiments, the bar 116 includes a first portion extending from the first end 112 of the grab bar 110, a second portion extending from the first portion that curls back toward the first end 112 of the grab bar 110, and a third portion extending from the second portion to the second end 114 of the grab bar 110. In some embodiments, the third portion of the bar 116 may be substantially parallel to the first portion of the bar 116.

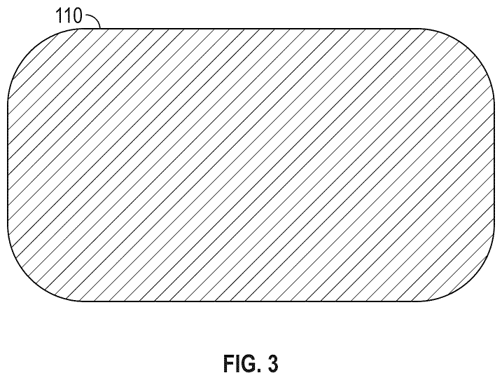

In some embodiments, the bar 116 may have a cross section profile that is configured to be ergonomically grasped by the user. Referring to the example embodiment shown in FIG. 3, the bar 116 may have a rectangular profile (e.g., a rectangular cross section, a rectangular grab bar, etc.) such that the bar 116 may be more easily grasped by a user. In some embodiments, the corners of the rectangular profile of the bar 116 may be rounded. The rectangular profile of the bar 116 may be configured to allow for the user of the grab bar 110 to securely grab the grab bar 110 when the grab bar 110 is slick (e.g., covered in a fluid, etc.). In other embodiments, the bar 116 may have a cross section profile with a different shape (e.g., a circular profile, an ovular profile, a hexagonal profile, an octagonal profile, a triangular profile, etc.).

Referring back to FIGS. 1 and 2, the grab bar 110 includes a plurality of bar mounting brackets 118 coupled to the bar 116. The bar mounting brackets 118 are configured to couple the grab bar 110 to a surface (e.g., a wall of a bathroom, etc.). In some embodiments, the bar mounting brackets 118 may be configured to couple the grab bar 110 to the surface using fasteners (e.g., bolts, screws, nails, etc.). In other embodiments, the bar mounting brackets 118 may include suction cups configured to suction to the surface. In various embodiments, the bar mounting brackets 118 may be configured to couple the grab bar 110 to the surface using alternate methods (e.g., adhesive, hooks, etc.).

In some embodiments, a first of the bar mounting brackets 118 is coupled to the bar 116 at the first end 112 of the grab bar 110 and a second of the bar mounting brackets 118 is coupled to the bar 116 at the second end 114 of the grab bar 110. In some embodiments, additional of the bar mounting brackets 118 (e.g., a third of the bar mounting brackets 118, a fourth of the bar mounting brackets 118, et.) are coupled to the bar 116 between the first end 112 of the grab bar 110 and the second end 114 of the grab bar 110. For example, for the grab bars with the first portion of the bar 116 extending perpendicularly relative to the second portion of the bar 116, a third of the bar mounting brackets 118 may be coupled to the first portion of the bar 116 proximate the interface between the first portion and the second portion and a fourth of the bar mounting brackets 118 may be coupled to the second portion of the bar 116 proximate the interface between the first portion and the second portion.

In some embodiments, the grab bar 110 includes a bar accessory 120 coupled to the bar 116. The bar accessory 120 may be an accessory associated with one of the elements of the home bathroom configuration. For example, if the grab bar 110 is coupled to a surface proximate a toilet, the bar accessory 120 may be a toilet paper mounting assembly (e.g., toilet paper holder, etc.) configured to hold (e.g., support, etc.) toilet paper. As another example, if the grab bar 110 is coupled to a surface proximate a sink, the bar accessory 120 may be a soap tray configured to hold soap. As yet another example, the bar accessory 120 may be a basket configured to hold an assortment of objects. In some embodiments, the bar accessory 120 may be releasably coupled to the bar 116. For example, if the grab bar 110 is coupled to a surface proximate a shower, the bar accessory 120 may be a shower caddy that is releasably coupled to the bar 116 such that the shower caddy can be removed from the bar 116.

The accessory mounting assembly 200 is releasably coupled to the grab bar 110 and is configured to receive an accessory 400 to releasably coupled the accessory 400 to the accessory mounting assembly 200. For example, the accessory 400 that the accessory mounting assembly 200 is configured to hold (e.g., grasp, support, etc.) may be a showerhead, a toothbrush, a hairbrush, or any other accessory that may be used in the home bathroom configuration (e.g., a hair dryer, a hair straightener, a light, etc.). In some embodiments, the accessory mounting assembly 200 may be along the grab bar 110 to move from a first position of the grab bar 110 to a second position on the grab bar 110. In other embodiments, the accessory mounting assembly 200 may be uncoupled from a first position on the grab bar 110 and coupled to a second position on the grab bar 110 in order to move from the first position on the grab bar 110 to the second position on the grab bar 110. In various embodiments, the accessory mounting assembly 200 may be uncoupled from a first position on the grab bar 110 on a first side of one of the bar mounting brackets 118 and coupled to a second position on the grab bar 110 on a second side of the one of the bar mounting brackets 118 in order to move from the first position on the grab bar 110 on the first side of the one of the bar mounting brackets 118 to the second position on the grab bar 110 on the second side of the one of the bar mounting brackets 118.

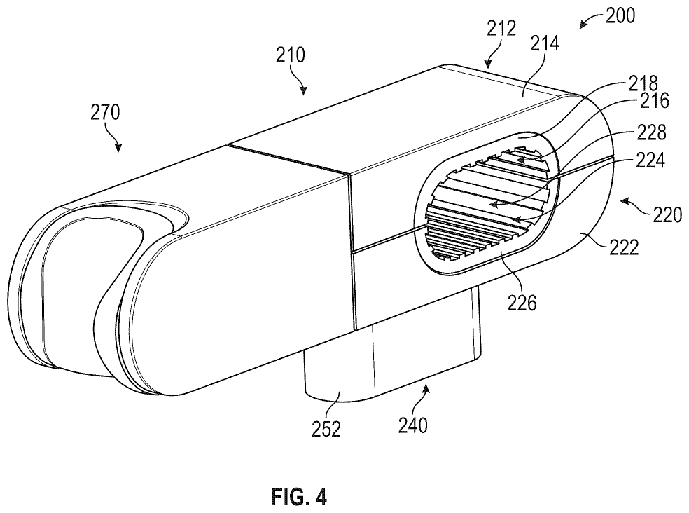

Referring to FIGS. 4-11, in some embodiments the accessory mounting assembly 200 includes a mounting bracket 210 (e.g., a clamp, etc.) configured to releasable couple the accessory mounting assembly 200 to the grab bar 110. The mounting bracket 210 includes a first mounting portion 212 (e.g., a first portion of the mounting bracket 210, an upper mounting portion, etc.). The first mounting portion 212 includes a first mounting body 214 (e.g., a first clamp body, an upper body, etc.). The first mounting body 214 defines a first channel 216 (e.g., an upper channel, etc.) configured to interface with the grab bar 110. For example, the first channel 216 may be configured to interface with, or be located in a confronting relation with, a first portion of a surface of the bar 116 when the accessory mounting assembly 200 is coupled to the grab bar 110. In some embodiments, the first channel 216 may be configured to interface with the grab bar 110 with the rectangular profile.

In some embodiments, the first mounting portion 212 includes a first grip 218 (e.g., an upper gripper, a first compressible element, etc.) coupled to the first mounting body 214 proximate the first channel 216 and configured to engage the bar 116 when the accessory mounting assembly 200 is coupled to the grab bar 110. For example, the first grip 218 may be formed from of a material with high friction properties (e.g., rubber, materials with a high surface roughness, materials with a low hardness, compressible materials, materials with higher friction properties than stainless steel, etc.). The first grip 218 interface with the first portion of the surface of the bar 116 to inhibit movement of the accessory mounting assembly 200 relative to the bar 116. In some embodiments, the accessory mounting assembly 200 is configured to compress the first grip 218 against the first portion of the surface of the bar 116 such that friction between the accessory mounting assembly 200 and the bar 116 is increased compared to when the first grip 218 is not compressed against the first portion of the surface of the bar 116. In various embodiments, the first grip 218 includes a raised profile (e.g., ridges, bumps, etc.) configured to engage the first portion of the surface of the bar 116.

The mounting bracket 210 includes a second mounting portion 220 (e.g., a second portion of the mounting bracket 210, a lower mounting portion, etc.). The second mounting portion 220 includes a second mounting body 222 (e.g., a second clamp body, a lower body, etc.). The second mounting body 222 defines a second channel 224 (e.g., a lower channel, etc.) configured to interface with the grab bar 110. For example, the second channel 224 may be configured to interface with, or be located in a confronting relation with, a second portion of the surface of the bar 116 opposite the first portion of the surface of the bar 116 when the accessory mounting assembly 200 is coupled to the grab bar 110. In some embodiments, the second channel 224 may be configured to interface with the grab bar 110 with the rectangular profile.

In some embodiments, the second mounting portion 220 includes a second grip 226 (e.g., a lower gripper, a second compressible element, etc.) coupled to the second mounting body 222 proximate the second channel 224 and configured to engage the bar 116 when the accessory mounting assembly 200 is coupled to the grab bar 110. For example, the second grip 226 may be formed out of and/or coated with a material with high friction properties. The second grip 226 may interface with the second portion of the surface of the bar 116 to inhibit movement of the accessory mounting assembly 200 relative to the bar 116. In some embodiments, the accessory mounting assembly 200 is configured to compress the second grip 226 against the second portion of the surface of the bar 116 such that friction between the accessory mounting assembly 200 and the bar 116 is increased compared to when the second grip 226 is not compressed against the second portion of the surface of the bar 116. In various embodiments, the second grip 226 includes a raised profile configured to engage the second portion of the surface of the bar 116.

When the second mounting portion 220 is coupled to the first mounting portion 212, the second mounting portion 220 and the first mounting portion 212 cooperatively (e.g., collectively, etc.) define a bar opening 228. The bar opening 228 is configured to receive the bar 116 of the grab bar 110. For example, when the second mounting portion 220 is coupled to the first mounting portion 212, a combination of the first channel 216 and the second channel 224 may form the bar opening 228. As such, when the second mounting portion 220 is coupled to the first mounting portion 212 around the bar 116 of the grab bar 110 to couple the accessory mounting assembly 200 to the grab bar 110, a portion of the bar 116 may be positioned within the bar opening 228. In some embodiments, when the second mounting portion 220 is coupled to the first mounting portion 212 around the bar 116 of the grab bar 110, the first mounting portion 212 and the second mounting portion 220 slidably couple the accessory mounting assembly 200 to the grab bar 110.

In some embodiments, the bar opening 228 may be substantially rectangular (e.g., when the first channel 216 and the second channel 224 are configured to interface with the bar 116 with the rectangular cross section, etc.). The bar opening 228 may extend in a direction (e.g., a first direction, etc.) parallel to a longitudinal axis extending along a length of the grab bar 110.

As a result, the accessory mounting assembly 200 may be releasably coupled to the bar 116 of any of the grab bars 110 regardless of an orientation of the bar 116. For example, the accessory mounting assembly 200 may be coupled to a first of the grab bars 110 when the bar 116 of the first of the grab bars 110 is orientated vertically (e.g., extending in a vertical direction, extending in a direction of gravity, a vertical installation, etc.), a second of the grab bars 110 when the bar 116 of the second of the grab bars 110 is orientated horizontally (e.g., extending in a horizontal direction, extending in a direction perpendicular to a direction of gravity, a horizontal installation, etc.), or a third of the grab bars 110 when the bar 116 of the third of the grab bars 110 is orientated at an angle (e.g., extending at an angle, extending at an angle to a direction of gravity, an angled installation, etc.).

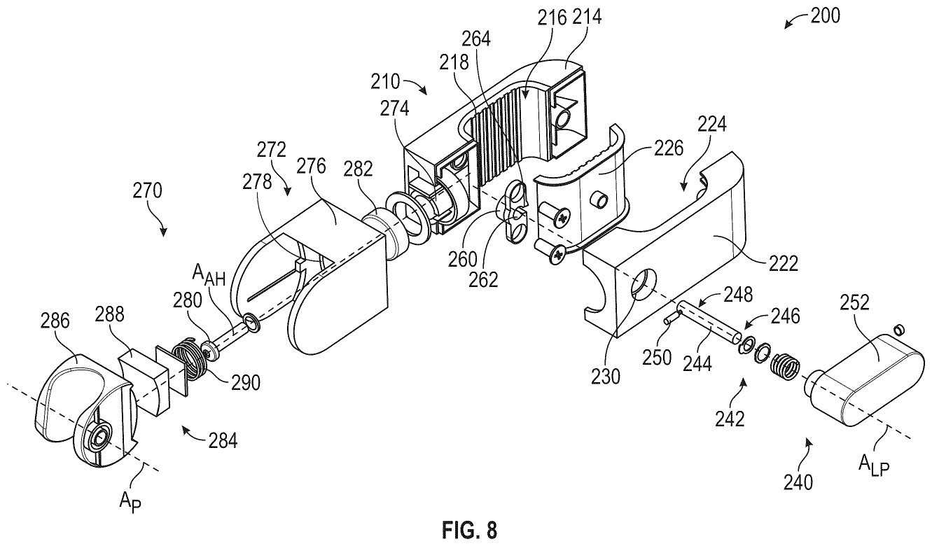

According to the example embodiment shown in FIG. 8, the second mounting body 222 of the second mounting portion 220 also defines a lock aperture 230 (e.g., a lock hole, a lock opening, etc.) extending through the second mounting body 222. In some embodiments, the lock aperture 230 is configured to allow access to the first mounting body 214 through the second mounting body 222 when the second mounting portion 220 is coupled to the first mounting portion 212. In other embodiments, the first mounting body 214 of the first mounting portion 212 defines the lock aperture 230 and the lock aperture 230 is configured to allow access to the second mounting body 222 through the first mounting body 214 when the first mounting portion 212 is coupled to the second mounting portion 220.

According to the example embodiment shown in FIGS. 4-8, the mounting bracket 210 includes a lock assembly 240. The lock assembly 240 is configured to releasably couple the first mounting portion 212 and the second mounting portion 220. In some embodiments the lock assembly 240 is repositionable between a first configuration where the lock assembly 240 is configured to couple the second mounting portion 220 to the first mounting portion 212 and a second configuration where the lock assembly 240 is configured to release the second mounting portion 220 from the first mounting portion 212. For example, a user may place the lock assembly 240 in a first configuration where the lock assembly 240 is configured to couple the second mounting portion 220 to the first mounting portion 212 or a second configuration where the lock assembly 240 is configured to release the second mounting portion 220 to the first mounting portion 212 (e.g., not couple to the second mounting portion 220 to the first mounting portion 212, etc.). In some embodiments, the second mounting portion 220 is pivotably coupled to the first mounting portion 212 (e.g., pivotably coupled by a hinge, pivotably coupled about a fastener, etc.) at a first end of the second mounting portion 220 and a first end of the first mounting portion 212 and the second mounting portion 220 is configured to releasably couple to the first mounting portion 212 at a second end of the second mounting portion 220 and a second end of the first mounting portion 212 (e.g., releasably coupled by the lock assembly 240 etc.). For example, a user may place the lock assembly 240 in a first configuration where the lock assembly 240 is configured to couple the second mounting portion 220 to the first mounting portion 212 at the second end of the second mounting portion 220 and the second end of the first mounting portion 212 or a second configuration where the lock assembly 240 is configured to release the second mounting portion 220 from the first mounting portion 212 at the second end of the second mounting portion 220 and the second end of the first mounting portion 212, but the second mounting portion 220 is still pivotably coupled to the first mounting portion 212 at the first end of the second mounting portion 220 and the first end of the first mounting portion 212 such that the second mounting portion 220 may pivot away from the first mounting portion 212 to receive the grab bar 110.

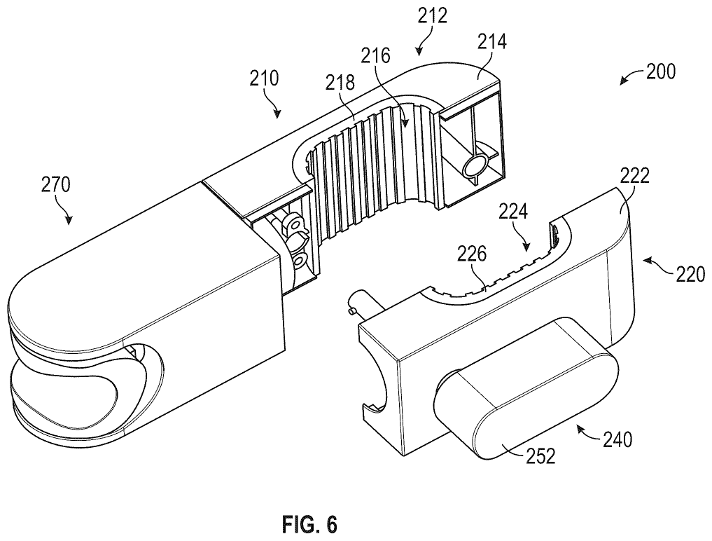

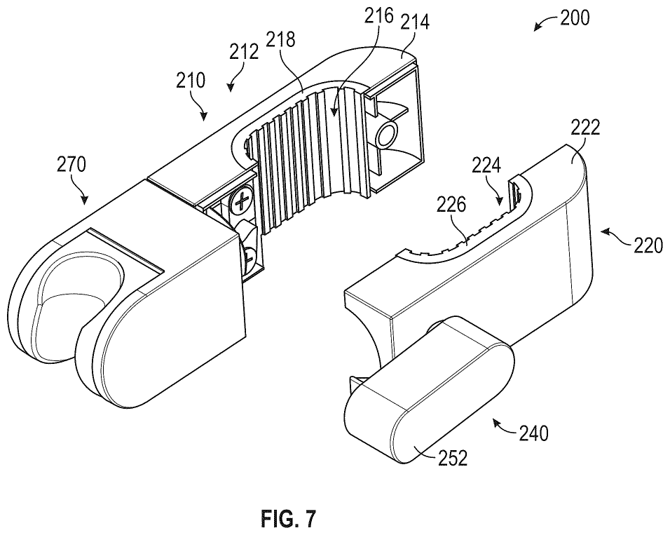

The lock assembly 240 includes a lock 242 rotatably coupled to the second mounting portion 220. The lock 242 is configured to rotate between a lock position (e.g., a first position of the lock 242, etc.) that places the lock assembly 240 in the first configuration (e.g., to couple the second mounting portion 220 to the first mounting portion 212, etc.) and an unlock position (e.g., a second position of the lock 242, etc.) that places the lock assembly 240 in the second configuration (e.g., to release the first mounting portion 212 from the second mounting portion 220, etc.). According to the example embodiment shown in FIGS. 6 and 7, the lock 242 is shown to be positioned in the lock position in FIG. 6 and the lock 242 is shown to be positioned in the unlock position in FIG. 7. In some embodiments, the lock 242 is positioned under the second channel 224 when the lock 242 is in the lock position. In various embodiments, the lock 242 is configured to rotate 180 degrees between the lock position and the unlock position. In other embodiments, the lock 242 is configured to rotate a different amount between the lock position and the unlock position (e.g., 30 degrees, 90 degrees, 270 degrees, 360 degrees, etc.).

The lock 242 includes a lock mandrel 244 rotatably coupled to the second mounting body 222. The lock mandrel 244 extends through the lock aperture 230. In some embodiments, the lock mandrel 244 is rotatably coupled to an aperture portion of the second mounting body 222 that defines the lock aperture 230. In some embodiments, the lock mandrel 244 is rotatably coupled to the second mounting body 222 using lock rings (e.g., e-rings, press rings, O-rings, etc.). The lock mandrel 244 includes a handle end 246 configured to be operated by a user of the accessory mounting assembly 200. The lock mandrel 244 includes a lock end 248 opposite of the handle end 246 configured to couple the second mounting portion 220 to the first mounting portion 212.

In some embodiments, the lock mandrel 244 includes a lock pin 250 coupled to the lock end 248 of the lock mandrel 244. The lock pin 250 is configured to couple the second mounting portion 220 to the first mounting portion 212. In some embodiments, the lock mandrel 244 defines a pin aperture on the lock end 248 of the lock mandrel 244 and the lock pin 250 extends into the pin aperture when the lock pin 250 is coupled to the lock mandrel 244. For example, the lock pin 250 may be coupled to the lock mandrel 244 by pressing the lock pin 250 into the pin aperture of the lock mandrel 244 (e.g., a press fit, etc.). In other embodiments, the lock pin 250 is coupled to the lock mandrel 244 using alternate methods (e.g., an adhesive, etc.) or the lock pin 250 and the lock mandrel 244 are integrally formed.

In some embodiments, the lock pin 250 is positioned along a lock pin axis A_{LP}. The lock 242 may be configured to rotate between the lock position and the unlock position around the lock pin axis A_{LP}. In some embodiments, the lock pin axis A_{LP} is configured to be perpendicular (e.g., 90 degrees off from, etc.) a direction of the bar opening 228. For example, when the accessory mounting assembly 200 is coupled to the bar 116, the lock pin axis A_{LP} may be orientated perpendicular to a direction of the extension of the bar 116 proximate the accessory mounting assembly 200.

The lock 242 includes a release arm 252 coupled to the handle end 246 of the lock mandrel 244. The release arm 252 may be configured to be rotated by the user of the accessory mounting assembly 200 to rotate the lock 242 between the lock position and the unlock position. For example, the release arm 252 may be configured as a handle that may be operated by the user. In some embodiments, the release arm 252 is coupled to the lock mandrel 244 with a pin that extends through a release arm aperture defined by the release arm 252 and into a first lock mandrel aperture defined by the lock mandrel 244 proximate the handle end 246 of the lock mandrel 244. In other embodiments, the release arm 252 is coupled to the lock mandrel 244 using alternate methods (e.g., an adhesive, etc.) or the lock mandrel 244 and the release arm 252 are integrally formed.

The lock assembly 240 includes a lock bracket 260 coupled to the first mounting body 214. According to the exemplary embodiment shown in FIG. 8, the lock bracket 260 is coupled to the first mounting body 214 with fasteners. In other embodiments, the lock bracket 260 is coupled to the first mounting body 214 using alternate methods (e.g., adhesive, etc.) or the lock bracket 260 is integrally formed with the first mounting body 214.

The lock bracket 260 includes a lock mandrel opening 262. The lock mandrel opening 262 is configured to align with the lock mandrel 244 to receive the lock mandrel 244 when the second mounting portion 220 is in a position to be releasably coupled to the first mounting portion 212 and the lock 242 is in the unlock position (e.g., the lock assembly 240 is in the second configuration to release the first mounting portion 212 from the second mounting portion 220, etc.). In some embodiments, the lock mandrel opening 262 is configured to receive the lock mandrel 244 when the second mounting portion 220 is in a position to be releasably coupled to the first mounting portion 212 and the lock 242 is in the lock position (e.g., the lock assembly 240 is in the first configuration to couple the first mounting portion 212 to the second mounting portion 220, etc.). For example, the lock mandrel opening 262 may be configured to adjust the lock 242 from the lock position to the unlock position when the lock mandrel 244 interfaces with the lock mandrel opening 262 and the lock 242 is in the lock position. For example, the lock mandrel opening 262 may include a ramp configured to rotate the lock 242 from the lock position to the unlock position when the lock mandrel 244 interfaces with the lock mandrel opening 262 and the lock 242 is in the lock position.

In some embodiments, the lock mandrel opening 262 may include a lock pin channel 264. The lock pin channel 264 is configured to align with the lock pin 250 to receive the lock pin 250 when the second mounting portion 220 is in a position to be releasably coupled to the first mounting portion 212 and the lock 242 is in the unlock position.

Once the lock mandrel opening 262 has received the lock mandrel 244, the lock 242 is in the unlock position, and the second mounting portion 220 is in a position to be releasably coupled to the first mounting portion 212, the lock mandrel opening 262 and the lock mandrel 244 are configured to couple the second mounting portion 220 to the first mounting portion 212 when the lock 242 is rotated from the unlock position to the lock position. For example, the lock mandrel opening 262 and the lock mandrel 244 may be configured to be releasably coupled when the lock 242 is rotated from the unlock position to the lock position to releasably couple the second mounting portion 220 to the first mounting portion 212.

In some embodiments, when the lock 242 is in the unlock position, the lock mandrel 244 and the lock mandrel opening 262 may be configured to partially couple the second mounting portion 220 to the first mounting portion 212 (e.g., couple the second mounting portion 220 to the first mounting portion 212 in a first direction, couple the second mounting portion 220 to the first mounting portion 212 in a first direction and a second direction, etc.). For example, the lock mandrel 244 and the lock mandrel opening 262 may be configured to couple the first mounting portion 212 and the second mounting portion 220 along the direction of the lock pin axis A_{LP} and directions perpendicular to the lock pin axis A_{LP}, but not rotationally. As a result, the second mounting portion 220 and the first mounting portion 212 may be configured to couple the first mounting portion 212 and the second mounting portion 220 in any of the directions that are not covered by the lock mandrel 244 and the lock mandrel opening 262. In other embodiments, the lock mandrel 244 and the lock mandrel opening 262 may be configured to fully couple the second mounting portion 220 to the first mounting portion 212 when the lock 242 is in the unlock position.

In some embodiments, the lock mandrel opening 262 may be configured to prevent the lock 242 from rotating from the unlock position to the lock position when the second mounting portion 220 is not in a position to be releasably coupled to the first mounting portion 212. For example, once the lock mandrel opening 262 has at least partially receive the lock mandrel 244, the lock mandrel opening 262 may be configured to prevent the rotation of the lock 242 from the unlock position to the lock position until the second mounting portion 220 is in a position to be releasably coupled to the first mounting portion 212 such that the lock 242 cannot be rotated prematurely from the unlock position to the lock position, which could result in the second mounting portion 220 and the first mounting portion 212 not being fully coupled.

In some embodiments, once the lock mandrel opening 262 has received the lock mandrel 244, the lock 242 is in the unlock position, and the second mounting portion 220 is in a position to be releasably coupled to the first mounting portion 212, the lock pin 250 and the lock pin channel 264 are configured to couple the second mounting portion 220 to the first mounting portion 212 when the lock 242 is rotated from the unlock position to the lock position. For example, the lock pin channel 264 may include a ledge (e.g., a cliff, etc.) configured to restrain (e.g., hold, prevent from moving, etc.) the lock pin 250 when the lock mandrel opening 262 has received the lock mandrel 244, the second mounting portion 220 is in a position to be releasably coupled to the first mounting portion 212, and the lock 242 is in the lock position. The ledge of the lock pin channel 264 may interface with the lock pin 250 to prevent the lock mandrel 244 from being removed from the lock mandrel opening 262 when the lock 242 is in the lock position, such that the second mounting portion 220 is coupled to the first mounting portion 212.

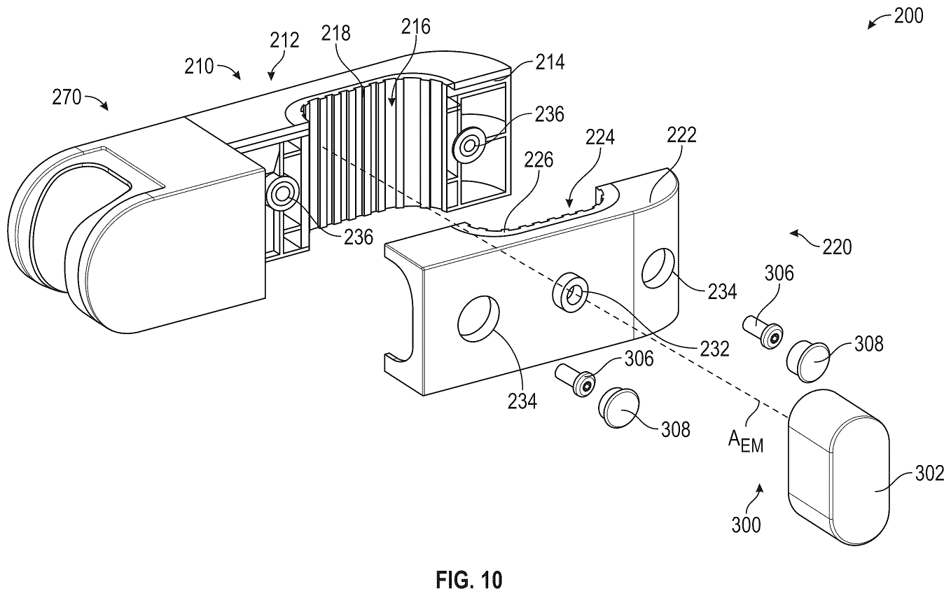

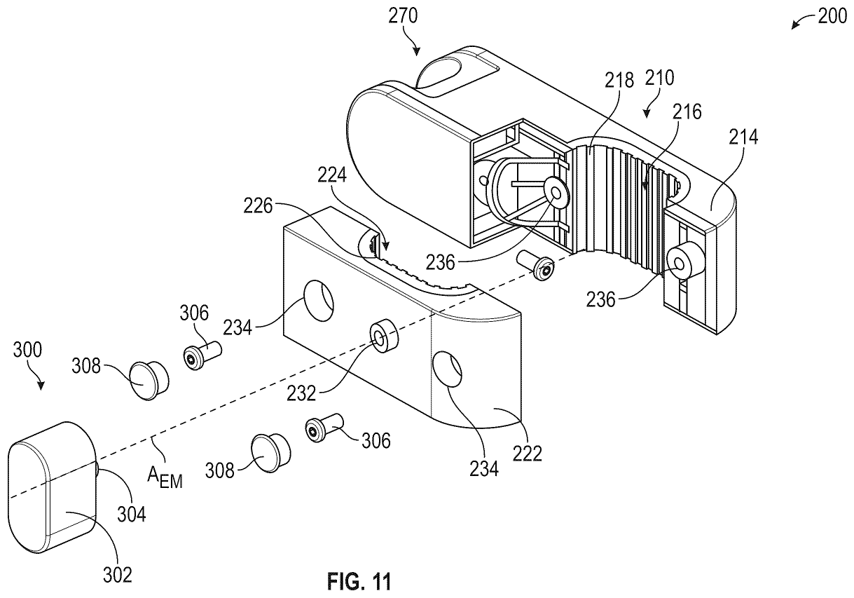

According to the example embodiment shown in FIGS. 10 and 11, the second mounting body 222 of the second mounting portion 220 also defines an engagement aperture 232 (e.g., an engagement hole, an engagement opening, etc.) extending through the second mounting body 222. In some embodiments, the engagement aperture 232 is configured to allow access to the first mounting body 214 through the second mounting body 222 when the second mounting portion 220 is coupled to the first mounting portion 212. In some embodiments, the engagement aperture 232 is configured to allow access to the bar opening 228 through the second mounting body 222 when the second mounting portion 220 is coupled to the first mounting portion 212. In other embodiments, the first mounting body 214 of the first mounting portion 212 defines the engagement aperture 232 and the engagement aperture 232 is configured to allow access to the second mounting body 222 through the first mounting body 214 when the first mounting portion 212 is coupled to the second mounting portion 220.

According to the example embodiment shown in FIGS. 10 and 11, the second mounting body 222 of the second mounting portion 220 also defines a plurality of fastener apertures 234 (e.g., fastener holes, fastener openings, etc.) extending through the second mounting body 222. In some embodiments, the fastener apertures 234 are configured to allow access to the first mounting body 214 through the second mounting body 222 when the second mounting portion 220 is coupled to the first mounting portion 212. In other embodiments, the first mounting body 214 of the first mounting portion 212 defines the fastener apertures 234 and the fastener apertures 234 are configured to allow access to the second mounting body 222 through the first mounting body 214 when the first mounting portion 212 is coupled to the second mounting portion 220. In still other embodiments, the second mounting body 222 or the first mounting body 214 only define one of the fastener apertures 234.

According to the example embodiment shown in FIGS. 10 and 11, the first mounting body 214 of the first mounting portion 212 also defines a plurality of receiving apertures 236 (e.g., receiving holes, receiving openings, etc.) extending at least partially through the first mounting body 214. The receiving apertures 236 are configured to align (e.g., be concentric, etc.) with the fastener apertures 234 when the first mounting portion 212 is coupled to the second mounting portion 220. In other embodiments, the second mounting body 222 of the second mounting portion 220 defines the receiving apertures 236 (e.g., when the first mounting body 214 defines the fastener apertures 234. In still other embodiments, the second mounting body 222 or the first mounting body 214 only define one of the receiving apertures 236. In various embodiments, the receiving apertures 236 each define threads configured to engage with a fastener, such that the fasteners are coupled to the receiving aperture 236 when engaged with the threads.

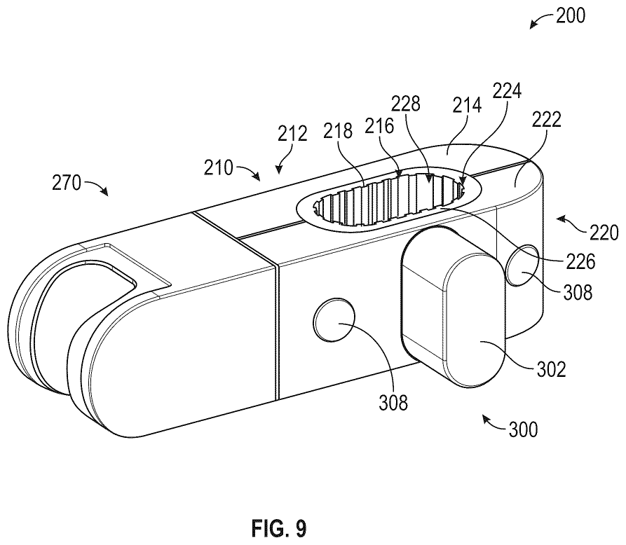

According to the example embodiment shown in FIGS. 9-11, the accessory mounting assembly 200 includes an engagement assembly 300. The engagement assembly 300 is configured to releasably engage (e.g., press in to, lock to, secure, etc.) the accessory mounting assembly 200 to the grab bar 110 when the accessory mounting assembly 200 is coupled to the grab bar 110. For example, the engagement assembly 300 may be configured to prevent (e.g., inhibit, etc.) the accessory mounting assembly 200 from sliding along the grab bar 110 when the engagement assembly 300 is engaged to the grab bar 110 and when the accessory mounting assembly 200 is coupled to the grab bar 110. In some embodiments, the engagement assembly 300 is repositionable between a first configuration where the engagement assembly 300 is configured to engage the grab bar 110 when the accessory mounting assembly 200 is coupled to the grab bar 110 and a second configuration where the engagement assembly is not configured to engage the grab bar 110 when the accessory mounting assembly 200 is coupled to the grab bar 110. For example, a user may place the engagement assembly 300 in a first configuration when the accessory mounting assembly 200 is coupled to the grab bar 110 where the engagement assembly 300 is configured to engage the grab bar 110 and prevent movement of the accessory mounting assembly 200 relative to the grab bar 110 or a second configuration when the accessory mounting assembly 200 is coupled to the grab bar 110 where the engagement assembly 300 is not configured to engage the grab bar 110 and the accessory mounting assembly 200 may be slid along the grab bar 110. In various embodiments, the engagement assembly 300 is configured to be manipulated by a user until the engagement assembly 300 engages the grab bar 110 when the accessory mounting assembly 200 is coupled to the grab bar 110.

The engagement assembly 300 includes an engagement portion 302 rotatably coupled to the second mounting portion 220. The engagement portion 302 is configured to rotate between an engagement position (e.g., a first position of the engagement portion 302, etc.) that places the engagement assembly 300 in the first configuration (e.g., to engage the grab bar 110 when the accessory mounting assembly 200 is coupled to the grab bar 110, etc.) and a disengagement position (e.g., a second position of the engagement portion 302, etc.) that places the engagement assembly 300 in the second configuration (e.g., to not engage the grab bar 110 when the accessory mounting assembly 200 is coupled to the grab bar 110, etc.). In various embodiments, the engagement portion 302 is configured to rotate 180 degrees between the engagement position and the disengagement position. In other embodiments, the engagement portion 302 is configured to rotate a different amount between the engagement position and the disengagement position (e.g., 30 degrees, 90 degrees, 270 degrees, 360 degrees, etc.).

The engagement portion 302 includes an engagement mandrel 304 (e.g., an engagement shaft, an engagement pin, etc.) rotatably coupled to the second mounting body 222. The engagement mandrel 304 extends through the engagement aperture 232. In some embodiments, the engagement mandrel 304 is rotatably coupled to an engagement aperture portion of the second mounting body 222 that defines the engagement aperture 232. In some embodiments, the engagement mandrel 304 is rotatably coupled to the second mounting body 222 using lock rings (e.g., e-rings, press rings, O-rings, etc.). The engagement mandrel 304 includes an engagement end distal from the engagement portion 302 configured to engage the grab bar 110 when the engagement portion 302 is in the engagement position and the accessory mounting assembly 200 is coupled to the grab bar 110. In various embodiments, the engagement mandrel 304 may be configured to extend through apertures defined by the grab bar 110 to engage the grab bar 110 and prevent the accessory mounting assembly 200 from sliding along the length of the grab bar 110.

In some embodiments, the engagement mandrel 304 is positioned along an engagement mandrel axis A_{EM}. The engagement portion 302 may be configured to rotate between the engagement position and the disengagement position around the engagement mandrel axis A_{EM}. In some embodiments, the engagement mandrel axis A_{EM} is configured to be perpendicular (e.g., 90 degrees off from, etc.) a direction of the bar opening 228. For example, when the accessory mounting assembly 200 is coupled to the bar 116, the engagement mandrel axis A_{EM} may be orientated perpendicular to a direction of the extension of the bar 116 proximate the accessory mounting assembly 200.

The engagement assembly 300 includes a plurality of fasteners 306 (e.g., screws, bolts, pins, etc.). The fasteners 306 are configured to releasably couple the second mounting body 222 to the first mounting body 214. In some embodiments, the fasteners 306 are configured to extend through the fastener apertures 234 into the receiving apertures 236 and are received by the receiving apertures 236 to couple the second mounting body 222 to the first mounting body 214. For example, the fasteners 306 may be configured to couple the second mounting portion 220 to the first mounting portion 212 when the fasteners 306 extend through the fastener apertures 234 and are received by the receiving apertures 236. In other embodiments, the engagement assembly 300 includes one of the fasteners 306 (e.g., when the accessory mounting assembly 200 defines one of the fastener apertures 234 and one of receiving apertures 236, etc.). In other embodiments, the engagement assembly 300 includes a single of the fasteners 306 configured to releasably couple the second mounting body 222 to the first mounting body 214 (e.g., when, the second mounting body 222 or the first mounting body 214 only define one of the fastener apertures 234, etc.).

In some embodiments, the engagement assembly 300 includes a plurality of covers 308. The covers 308 are configured to cover the fasteners 306 when the fasteners 306 extend through the fastener apertures 234 and are received by the fastener apertures 234. In some embodiments, the covers 308 are coupled to the fastener apertures 234 (e.g., press fit, threaded into the fastener apertures, 234, etc.). The covers 308 may be flush with an outside surface of the first mounting body 214 or the second mounting body 222.

The accessory mounting assembly 200 includes an accessory mount 270 (e.g., an accessory holder, an accessory mounting sub-assembly, an accessory mount portion, etc.) coupled to the mounting bracket 210. The accessory mount 270 is configured is configured be releasably coupled to the accessory 400. In some embodiments, a portion of the accessory mount 270 is configured to rotate relative to the mounting bracket 210 such that a rotational orientation of the accessory 400 relative to the mounting bracket 210 may be adjusted by rotating the portion of the accessory mount 270 relative to the mounting bracket 210.

In some embodiments, the accessory mount 270 includes a rotational assembly 272 rotatably coupled to the first mounting portion 212. The rotational assembly 272 may be configured to rotate the portion of the accessory mount 270 such that the rotational orientation of the accessory 400 may be adjusted relative to the mounting bracket 210. In other embodiments, the accessory mount 270 does not include the rotational assembly 272 (e.g., when the accessory mount 270 is not configured to rotate relative to the mounting bracket 210, etc.).

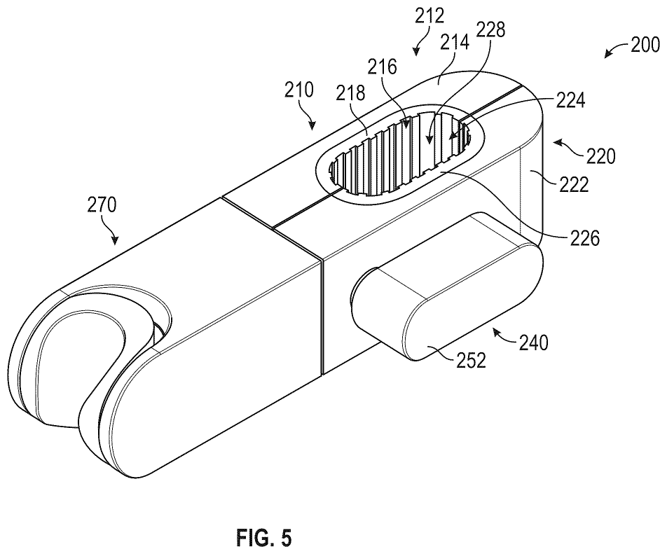

According to the example embodiment shown in FIGS. 4 and 5, the rotational assembly 272 is shown to be positioned in different positions that would result in different rotational orientations of the accessory 400 if the accessory 400 were coupled to the accessory mount 270. For example, as shown in FIG. 4, the rotational assembly 272 is shown to be positioned in a perpendicular position relative to a direction of the extension of the bar 116 proximate the accessory mounting assembly 200 such that the accessory 400 would be orientated perpendicularly to the direction of the extension of the bar 116 when the accessory 400 is coupled to the accessory mount 270. As shown in FIG. 5, the rotational assembly 272 is shown to be positioned in a parallel position relative to a direction of the extension of the bar 116 proximate the accessory mounting assembly 200 such that the accessory 400 would be orientated parallel to the direction of the extension of the bar 116 when the accessory 400 is coupled to the accessory mount 270. In various embodiments, the rotational assembly 272 may be positioned in positions between the parallel position and the perpendicular position such that the that the accessory 400 would be orientated at an angle (e.g., an angle between 0 degrees and 90 degrees, etc.) to the direction of the extension of the bar 116 when the accessory 400 is coupled to the accessory mount 270.

The rotational assembly 272 includes a rotational base 274 coupled to the first mounting body 214 of the first mounting portion 212. In various embodiments, the rotational base 274 is integrally formed with the first mounting body 214. The rotational assembly 272 includes a rotational bracket 276 (e.g., a rotational body, etc.) rotatably coupled to the rotational base 274. The rotational bracket 276 may be configured to support the accessory 400. In some embodiments, the rotational base 274 may include a locking pin extending toward the rotational bracket 276 configured to limit rotation of the rotational bracket 276 (e.g., limit rotation of the rotational bracket 276 to 360 degrees, limit rotation of the rotational bracket 276 to 270 degrees, limit rotation of the rotational bracket 276 to 180 degrees, limit rotation of the rotational bracket 276 to 90 degrees, etc.).

In some embodiments, the rotational bracket 276 is configured to rotate about an accessory rotation axis A_{AR}. The accessory rotation axis A_{AR} may be perpendicular to the lock pin axis A_{LP} or the engagement mandrel axis A_{EM}. The accessory rotation axis A_{AR} may be orientated perpendicular to a direction of the extension of the bar 116 proximate the accessory mounting assembly 200. In some embodiments, the accessory rotation axis A_{AR} is perpendicular to the lock pin axis A_{LP} or the engagement mandrel axis A_{EM} and orientated perpendicular to a direction of the extension of the bar 116 proximate the accessory mounting assembly 200. In various embodiments, the accessory rotation axis A_{AR} intersects the lock pin axis A_{LP} or the engagement mandrel axis A_{EM} and/or the bar opening 228 when the second mounting portion 220 is couple to the first mounting portion 212. In some embodiments, the accessory rotation axis A_{AR} intersects the bar 116 of the grab bar 110 when the accessory mounting assembly 200 is coupled to the grab bar 110.

In some embodiments, the rotational bracket 276 defines a rotational aperture 278 (e.g., a fastener aperture, etc.) extending through the rotational bracket 276. In some embodiments, the rotational aperture 278 is configured to allow access to the first mounting body 214 through the rotational bracket 276 when accessory mount 270 is rotatably coupled to the mounting bracket 210. In some embodiments, the rotational assembly 272 includes a rotational fastener 280 configured to rotatably couple the rotational bracket 276 and the rotational base 274. The rotational fastener 280 may extend through the rotational aperture 278 and couple to the rotational base 274 such that the rotational bracket 276 may rotate around the rotational fastener 280 relative to the rotational base 274. In other embodiments, the rotational bracket 276 does not define the rotational aperture 278, the rotational bracket 276 is not rotatably coupled to the rotational base 274 with the rotational fastener 280, and the rotational bracket 276 is rotatably coupled to the rotational base 274 using other methods (e.g., a press fit lazy susan, etc.).

The rotational assembly 272 includes a rotational friction pad 282 positioned between the rotational bracket 276 and the rotational base 274, according to some embodiments. The rotational friction pad 282 is configured to provide a rotational friction between the rotational bracket 276 and the rotational base 274. In some embodiments, the rotational friction pad 282 may be configured to provide a rotational friction that is sufficient to prevent the rotation of the rotational bracket 276 relative to the rotational base 274 when the accessory mount 270 is releasably coupled to the accessory 400 without an outside force being applied to the accessory mount 270. For example, the rotational friction pad 282 may hold the rotational bracket 276 in a position relative to the rotational base 274 until a user applies a rotational force on the rotational bracket 276 (e.g., directly to the rotational bracket 276, to the rotational bracket 276 through the accessory 400, etc.). As a result, a user may adjust the rotational orientation of the accessory 400 when the accessory mount 270 is releasably coupled to the accessory 400 and the accessory mount 270 may hold the accessory 400 at the same rotational orientation until receiving an additional adjustment of the user.

The accessory mount 270 includes a gripper assembly 284. The gripper assembly 284 is configured to be releasably coupled to the accessory 400 such that the accessory mounting assembly 200 may be configured to support the accessory 400. In some embodiments, the gripper assembly 284 is configured to pivot the accessory 400 relative to the mounting bracket 210 such that an angular orientation of the accessory 400 relative to the mounting bracket 210 may be adjusted.

The gripper assembly 284 may be configured to pivot the accessory 400 around a pivot axis A_{P}. In some embodiments, the pivot axis A_{P} intersects the accessory rotation axis A_{AR}. In some embodiments, an angle between the pivot axis A_{P} and the lock pin axis A_{LP} or the engagement mandrel axis A_{EM} may vary depending on the rotational orientation the accessory mount 270 based on a rotational position of the rotational bracket 276 relative to the rotational base 274. For example, the angle between the pivot axis A_{P} and the lock pin axis A_{LP} or the engagement mandrel axis A_{EM} may vary between 0 degrees and 360 degrees based on the rotational position of the rotational bracket 276 relative to the rotational base 274.

In some embodiments, the rotational bracket 276 is configured to rotate about an accessory rotation axis A_{AR}. The accessory rotation axis A_{AR} may be perpendicular to the lock pin axis A_{LP} or the engagement mandrel axis A_{EM}. The accessory rotation axis A_{AR} may be orientated perpendicular to a direction of the extension of the bar 116 proximate the accessory mounting assembly 200. In some embodiments, the accessory rotation axis A_{AR} is perpendicular to the lock pin axis A_{LP} or the engagement mandrel axis A_{EM} and orientated perpendicular to a direction of the extension of the bar 116 proximate the accessory mounting assembly 200. In various embodiments, the accessory rotation axis A_{AR} intersects the lock pin axis A_{LP} or the engagement mandrel axis A_{EM} and/or the bar opening 228 when the second mounting portion 220 is couple to the first mounting portion 212. In some embodiments, the accessory rotation axis A_{AR} intersects the bar 116 of the grab bar 110 when the accessory mounting assembly 200 is coupled to the grab bar 110.

The gripper assembly 284 includes a gripper body 286. The gripper body 286 is configured to be releasably coupled to the accessory 400. In some embodiments, the accessory 400 may be specifically configured to be releasably coupled to the gripper body 286. For example, the accessory 400 may be provided with the grab bar assembly 100 and designed to be releasably coupled to the gripper body 286. In various embodiments, the gripper body 286 may be configured to be releasably coupled to a wide variety of the accessories 400. For example, the gripper body 286 may be configured to be releasably coupled to multiple showerheads such that each of the multiple shower heads may be releasably coupled to the gripper body 286. In some embodiments, there may be multiple versions of the gripper body 286 configured to be releasably coupled to different of the accessories 400 and a version of the gripper body 286 may be included in the gripper assembly 284 based on which of the different of the accessories 400 is desired to be releasably coupled to the gripper assembly 284.

In some embodiments, the gripper body 286 is pivotably coupled to the rotational bracket 276 of the rotational assembly 272 such that the gripper body 286 is configured to rotate about the pivot axis A_{P} relative to the rotational bracket 276. For example, the gripper body 286 may be pivotably coupled to the rotational bracket 276 with a fastener configured to allow the gripper body 286 to pivot relative to the rotational bracket 276. The rotational bracket 276 and the gripper body 286 may be configured to limit the pivoting of the gripper body 286 relative to the rotational bracket 276 between a maximum pivot range. For example, the gripper body 286 or the rotational bracket 276 may include hard stops configured to limit rotation of the gripper body 286 relative to the rotational bracket 276. The maximum pivot range of the gripper body 286 may be 90 degrees, or 60 degrees, or 30 degrees, or 15 degrees. In other embodiments, the gripper body 286 is pivotably coupled to the mounting bracket 210 (e.g., when the accessory mount 270 does not include the rotational assembly 272, etc.).

In some embodiments, the gripper assembly 284 includes a pivot friction pad 288 positioned between the rotational bracket 276 and the gripper body 286. The pivot friction pad 288 is configured to provide a pivot friction between the rotational bracket 276 and the gripper body 286. In some embodiments, the pivot friction pad 288 may be configured to provide a pivot friction that is sufficient to prevent the pivoting of the gripper body 286 relative to the rotational bracket 276 when the accessory mount 270 is releasably coupled to the accessory without an outside force being applied to the accessory mount 270. For example, the pivot friction pad 288 may hold the gripper body 286 in a position relative to the rotational bracket 276 until a user applies a pivot force on the gripper body 286 (e.g., directly to the gripper body 286, to the gripper body 286 through the accessory 400, etc.). As a result, a user may adjust the angular orientation of the accessory 400 when the accessory mount 270 is releasably coupled to the accessory 400 and the accessory mount 270 may hold the accessory 400 at the same angular orientation until receiving an additional adjustment of the user. In other embodiments, the pivot friction pad 288 is positioned between the gripper body 286 and the mounting bracket 210 (e.g., when the accessory mount 270 does not include the rotational assembly 272, etc.).

In some embodiments, the gripper assembly 284 includes a spring 290. The spring 290 is positioned between the rotational bracket 276 and the pivot friction pad 288 and is configured to apply a spring force on the pivot friction pad 288 that presses the pivot friction pad 288 into the gripper body 286. In various embodiments, the spring 290 may be configured to apply a spring force on the pivot friction pad 288 that results in the pivot friction pad 288 applying a pivot force on the gripper body 286 that is sufficient to hold the gripper body 286 in a position relative to the rotational bracket 276 (e.g., until a user applies a pivot force on the gripper body 286, etc.). In various embodiments, a size of the spring 290 may be selected based on the accessory 400 that the accessory mounting assembly 200 is configured to support. For example, the spring 290 may be larger if the accessory 400 is heavier and the spring 290 may be smaller if the accessory 400 is lighter.

### III. Construction of Example Embodiments

The terms “coupled,” “connected,” and the like, as used herein, mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The construction and arrangement of the elements of the debris-reducing drain insert as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements, the position of elements may be reversed or otherwise varied, and the nature or number of discrete elements or positions may be altered or varied.

Additionally, the word “exemplary” is used to mean serving as an example, instance, or illustration. Any embodiment or design described herein as “exemplary” is not necessarily to be construed as preferred or advantageous over other embodiments or designs (and such term is not intended to connote that such embodiments are necessarily extraordinary or superlative examples). Rather, use of the word “exemplary” is intended to present concepts in a concrete manner. Accordingly, all such modifications are intended to be included within the scope of the present disclosure. Other substitutions, modifications, changes, and omissions may be made in the design, operating conditions, and arrangement of the preferred and other exemplary embodiments without departing from the scope of the appended claims.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Other substitutions, modifications, changes, and omissions may also be made in the design, operating conditions, and arrangement of the various exemplary embodiments without departing from the scope of the present invention. For example, any element (e.g., cutting blade, cutting plate, cover, impeller, support structure etc.) disclosed in one embodiment may be incorporated or utilized with any other embodiment disclosed herein. Also, for example, the order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes, and omissions may be made in the design, operating configuration, and arrangement of the preferred and other exemplary embodiments without departing from the scope of the appended claims.

What is claimed is:

1. An accessory mounting assembly for mounting an accessory on a grab bar, the accessory mounting assembly comprising:
an accessory mount configured to releasably couple to the accessory; and
a mounting bracket assembly comprising:
a first mounting portion coupled to the accessory mount, and
a second mounting portion releasably coupled to the first mounting portion;
wherein when the second mounting portion is coupled to the first mounting portion, the first mounting portion and the second mounting portion collectively define a bar opening configured to receive a portion of the grab bar to couple the accessory mounting assembly to the grab bar.

2. The accessory mounting assembly of claim 1, wherein the mounting bracket assembly comprises a lock assembly adjustable between a first configuration that couples the second mounting portion to the first mounting portion and a second configuration that releases the second mounting portion from the first mounting portion.

3. The accessory mounting assembly of claim 1, wherein:
the grab bar is a rectangular grab bar; and
the bar opening is a rectangular grab bar opening to interface with the rectangular grab bar

4. The accessory mounting assembly of claim 1, wherein the portion of the grab bar is positioned between the first mounting portion and the second mounting portion when the portion of the grab bar is received within the bar opening.

5. The accessory mounting assembly of claim 1, wherein the first mounting portion and the second mounting portion slidably couple the accessory mounting assembly to the grab bar when the portion of the grab bar is received within the bar opening.

6. The accessory mounting assembly of claim 5, wherein:
the first mounting portion comprises a first mounting body;
the second mounting portion comprises a second mounting body; and
at least one of the first mounting portion or the second mounting portion comprises a compressible element positioned between at least one of (i) the first mounting body and the portion of the grab bar or (ii) the second mounting body and the portion of the grab bar, the compressible element configured to be compressed between the at least one of (i) the first mounting body and the portion of the grab bar or (ii) the second mounting body and the portion of the grab bar to inhibit movement of the accessory mounting assembly relative to the grab bar.

7. The accessory mounting assembly of claim 5, further comprising an engagement assembly adjustable between a first configuration where the engagement assembly engages the portion of the grab bar to inhibit movement of the accessory mounting assembly relative to the grab bar and a second configuration where the engagement assembly releases the portion of the grab bar.

8. The accessory mounting assembly of claim 1, wherein:
the first mounting portion defines a first aperture extending at least partially through the first mounting portion; and
the second mounting portion defines a second aperture extending at least partially through the second mounting portion, the second aperture configured to selectively align with the first aperture to receive a fastener to couple the second mounting portion to the first mounting portion.

9. The accessory mounting assembly of claim 1, wherein the accessory mount comprises:
a rotational assembly rotatably coupled to the first mounting portion such that the accessory mount may rotate relative to the first mounting portion about a first axis; and
a gripper assembly pivotably coupled to the rotational assembly such that the gripper assembly may pivot relative to the rotational assembly about a second axis, the gripper assembly including a gripper body configured to releasably couple the accessory to the accessory mounting assembly.

10. The accessory mounting assembly of claim 9, wherein the second axis is substantially perpendicular to the first axis.

11. The accessory mounting assembly of claim 9, wherein the first axis intersects the bar opening when the second mounting portion is coupled to the first mounting portion.

12. The accessory mounting assembly of claim 9, wherein:
the mounting bracket assembly comprises a lock mandrel rotatable around a third axis between a first configuration that couples the second mounting portion to the first mounting portion and a second configuration that releases the second mounting portion from the first mounting portion; and
the third axis is substantially perpendicular to the first axis.

13. A grab bar assembly comprising:
a grab bar configured to be coupled to a surface; and
an accessory mounting assembly configured to mount an accessory on the grab bar, the accessory mounting assembly comprising:
an accessory mount configured to releasably couple to an accessory,
a mounting bracket assembly comprising:
a first mounting portion coupled to the accessory mount, the first mounting portion defining a first aperture; and
a second mounting portion defining a second aperture, and
a lock assembly configured to selectively align with and extend through the first aperture and the second aperture to selectively couple the second mounting portion to the first mounting portion, the lock assembly adjustable between a first configuration that couples the second mounting portion to the first mounting portion and a second configuration that releases the second mounting portion from the first mounting portion, wherein the first mounting portion and the second mounting portion releasably couple the accessory mounting assembly to the grab bar when a portion of the grab bar is positioned between the first mounting portion and the second mounting portion and the lock assembly is in the first configuration.

14. The grab bar assembly of claim 13, wherein:
the grab bar is a rectangular grab bar; and
the first mounting portion and the second mounting portion are configured to interface with the rectangular grab bar to slidably couple the mounting bracket assembly to the portion of the grab bar.

15. The grab bar assembly of claim 13 wherein when the lock assembly is in the first configuration, the first mounting portion and the second mounting portion collectively define a bar opening that receives the portion of the grab bar, the bar opening extending in a first direction parallel to a longitudinal axis of the grab bar.

16. The grab bar assembly of claim 13, wherein the accessory mount comprises:
a rotational assembly rotatably coupled to the first mounting portion such that the accessory mount may rotate relative to the first mounting portion about a first axis; and
a gripper assembly pivotably coupled to the rotational assembly such that the gripper assembly may pivot relative to the rotational assembly about a second axis, the gripper assembly including a gripper body configured to releasably couple the accessory to the accessory mounting assembly.

17. An accessory mounting assembly for mounting an accessory on a grab bar, the accessory mounting assembly comprising:
an accessory mount configured to releasably couple to the accessory;
a mounting bracket assembly comprising:
a first mounting portion coupled to the accessory mount, the first mounting portion defining a first aperture, and
a second mounting portion defining a second aperture configured to selectively align with the first aperture to receive a fastener to releasably couple the second mounting portion to the first mounting portion, wherein the first mounting portion and the second mounting portion releasably couple the accessory mounting assembly to the grab bar when a portion of the grab bar is positioned between the first mounting portion and the second mounting portion and the fastener couples the second mounting portion to the first mounting portion; and
an engagement assembly adjustable between a first configuration where the engagement assembly engages the portion of the grab bar to inhibit movement of the accessory mounting assembly relative to the grab bar and a second configuration where the engagement assembly releases the portion of the grab bar.

18. The accessory mounting assembly of claim 17, wherein:
the grab bar is a rectangular grab bar; and
the first mounting portion and the second mounting portion are configured to interface with the rectangular grab bar to slidably couple the mounting bracket assembly to the portion of the grab bar.

19. The accessory mounting assembly of claim 17, wherein the accessory mount comprises:
a rotational assembly rotatably coupled to the first mounting portion such that the accessory mount may rotate relative to the first mounting portion about a first axis; and
a gripper assembly pivotably coupled to the rotational assembly such that the gripper assembly may pivot relative to the rotational assembly about a second axis, the gripper assembly including a gripper body configured to releasably couple the accessory to the accessory mounting assembly.

20. The accessory mounting assembly of claim 19, wherein the second axis is substantially perpendicular to the first axis.
